(19) United States
(12) Patent Application Publication
(10) Pub. No.: US 2015/0214663 A1
(43) Pub. Date: Jul. 30, 2015

(54) CONNECTOR ASSEMBLY FOR VEHICLE

(71) Applicants: Hyundai Motor Company, Seoul (KR); Kia Motors Corporation, Seoul (KR); Korea Electric Terminal Co., Ltd., Incheon (KR)

(72) Inventors: Mun Jong Kim, Suwon (KR); Ig Kyun Jeon, Yongin (KR); Myung Hun Kim, Incheon (KR)

(21) Appl. No.: 14/533,755

(22) Filed: Nov. 5, 2014

(30) Foreign Application Priority Data
Jan. 29, 2014 (KR) 10-2014-0011178

(51) Int. Cl. H01R 13/639

(52) U.S. Cl. CPC H01R 13/639

(57) ABSTRACT

A connector assembly includes a coupling assurance structure that is integrally formed on a connector. The connector assembly includes a first connector installed with a terminal, a second connector coupled to the first connector and installed with a terminal connected to the terminal of the first connector, a locking lever disposed on the second connector and including a locking protrusion, a lever insertion part disposed on the first connector such that the locking lever of the second connector is inserted into the lever insertion part and including a stopping part for stopping the locking protrusion, and a coupling assurance part integrally formed with the lever insertion part and the locking lever and supporting the locking lever so as to maintain a locking state between the locking protrusion and the stopping part after the first and second connectors are coupled to each other.

### CROSS-REFERENCE TO RELATED APPLICATION

This application claims under 35 U.S.C. §119(a) the benefit of Korean Patent Application No. 10-2014-0011178 filed on Jan. 29, 2014, the entire contents of which are incorporated herein by reference.

### BACKGROUND

(a) Technical Field

The present invention relates to a connector assembly. More particularly, it relates to a connector assembly with a coupling assurance structure that is integrally formed on a connector.

(b) Description of the Related Art

Generally, a connector is a connection component used to electrically connect one circuit to another circuit. In vehicles, connectors are used to connect cables or wires.

Recently, the number of electronic parts mounted in vehicles for user convenience has increased significantly. Accordingly, the number of cables and wires that are required is also increasing, and thus a great number of connectors are being used to connect the required cables and wires.

Generally, such connectors include male and female connectors that are coupled to each other. Each connector has a space in which terminals can be accommodated. It is conventional that one connector accommodates a plurality of terminals.

In this case, a terminal of a male connector is formed to have a pin-like shape so as to be inserted into a terminal of a female connector. When the male connector and the female connector are coupled to each other, the terminal of the male connector is inserted into the terminal of the female connector, enabling an electrical connection.

Since connectors are designed for an electric connection, reliable and mechanical coupling is essential.

Accordingly, various methods are being used to ensure reliable coupling. In case of an electrical wiring system for a vehicle in which the coupling assurance of connectors has an important influence on safety, more reliable coupling assurance of connectors is needed.

To this end, Connector Position Assurances (CPAs) are used as a technology for preventing a danger of disconnection of connectors by a wire harness or the like.

The CPAs are designed to prevent a locking lever from being unlocked. The locking lever is a part that locks both connectors so as not to be separated from each other.

The locking lever is formed on one connector (e.g., formed on a connector housing), and is locked with a coupling part of the other connector when both connectors are coupled to each other.

In this case, the CPA supports the locking lever so as to prevent unlocking of the both connectors that are coupled to each other. When the locking lever needs to be released, the release of the locking lever is possible only after the CPA is released.

Accordingly, the disconnection of connectors due to an unintended release of the locking lever can be prevented by the CPA.

A connector including a CPA is disclosed in Korean Patent No. 10-0818629. A CPA for a general connector is separately manufactured to be coupled to a connector housing.

In other words, a separately manufactured CPA is coupled to a connector housing of one connector. When the CPA is inserted under the locking lever after the coupling of both connectors, the CPA supports and prevents the locking lever from sagging and releasing such that both connectors are not separated from each other due to a deformation of the locking lever by an external force.

However, since the CPA as described above is a component that is manufactured separately from a connector housing to be assembled, the number of components increases, and thus the manufacturing cost increases. Also, since a separate process is needed for assembling, assembly time including labor costs increase.

There is also a limitation in that the whole size of a connector increases due to the volume of the CPA.

The above information disclosed in this Background section is only for enhancement of understanding of the background of the invention and therefore it may contain information that does not form the prior art that is already known in this country to a person of ordinary skill in the art.

### SUMMARY

The present invention provides a connector assembly with a coupling assurance structure that is integrally formed on a connector, and thus can overcome a drawback associated with a conventional Connector Position Assurance (CPA) that is separately manufactured and assembled.

In one aspect, the present invention provides a connector assembly comprising: a first connector installed with a terminal; a second connector coupled to the first connector and insertedly installed with a terminal connected to the terminal of the first connector; a locking lever disposed on the second connector and comprising a locking protrusion; a lever insertion part disposed on the first connector such that the locking lever of the second connector is inserted into the lever insertion part and comprising a stopping part for stopping the locking protrusion; and a coupling assurance part integrally formed with the lever insertion part and the locking lever and supporting the locking lever so as to maintain a locking state between the locking protrusion and the stopping part after the first and second connectors are coupled to each other.

In an exemplary embodiment, the coupling assurance part may include: a seating part laterally protruding from an lower end of the lever insertion part; and a protrusion part integrally formed to have a protruding structure from a side surface of the locking lever, and the seating part may be inserted into a lower side of the protrusion part to support the locking lever.

In another exemplary embodiment, the lever insertion part and the seating part may be formed to have a sectional shape of “└ ┘”, and may be longitudinally disposed on an inner surface of the first connector in an insertion space of the first connector along an insertion direction of the second connector such that the locking lever and the protrusion part are inserted into the lever insertion part and the seating part.

In still another exemplary embodiment, the protrusion part may be integrally formed while protruding from both side surfaces of the end portion of the locking lever such that the end portion of the locking lever has a shape extending to left and right sides.

In yet another exemplary embodiment, the seating part may be formed at such a height as to push up the locking lever when being inserted into the lower side of the protrusion part.

In still yet another exemplary embodiment, the connector assembly may include a guide channel provided on an inner surface of an insertion space of the first connector for receiving the second connector by forming a protrusion of a “└ ┘” shape along the insertion direction of the second connector and a guide rib longitudinally disposed in the second connector along the insertion direction of the second connector to be inserted into each guide channel.

A coupling process of first and second connectors of a connector assembly can include steps of: inserting the second connector into an insertion space of the first connector; inserting a locking lever of the second connector into a lever insertion part disposed on the first connector, the first connector including a stopping part that protrudes from the lever insertion part of the first connector to stop a locking protrusion of the locking lever; and providing a coupling assurance part integrally formed with the lever insertion part and the locking lever and supporting the locking lever so as to maintain a locking state between the locking protrusion and the stopping part after the first and second connectors are coupled to each other. Other aspects and exemplary embodiments of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a perspective view illustrating a configuration of a connector assembly according to an embodiment of the present invention;

FIG. 2 is a cross-sectional perspective view illustrating a first connector of the connector assembly of FIG. 1;

FIG. 3 is a cross-section side view illustrating coupling of first and second connectors of the connector assembly of FIG. 1;

FIG. 4 is a perspective view illustrating coupling of the first and second connectors of the connector assembly of FIG. 3;

FIG. 5 is a perspective view illustrating a coupling state of the first and second connectors just before coupling is completed according to FIGS. 3 and 4; and

FIG. 6 is a view illustrating a coupling process of connectors of a connector assembly according to an embodiment of the present invention.

It should be understood that the accompanying drawings are not necessarily to scale, presenting a somewhat simplified representation of various exemplary features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Further, the control logic of the present invention may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

The above and other features of the invention are discussed infra.

Hereinafter, exemplary embodiments of the present invention will be described in detail with reference to the accompanying drawings so that those skilled in the art can easily carry out the present invention.

The present invention provides a connector assembly with a coupling assurance structure that is integrally formed on a connector housing, and thus can overcome a drawback associated with a conventional Connector Position Assurance (CPA) that is separately manufactured and assembled.

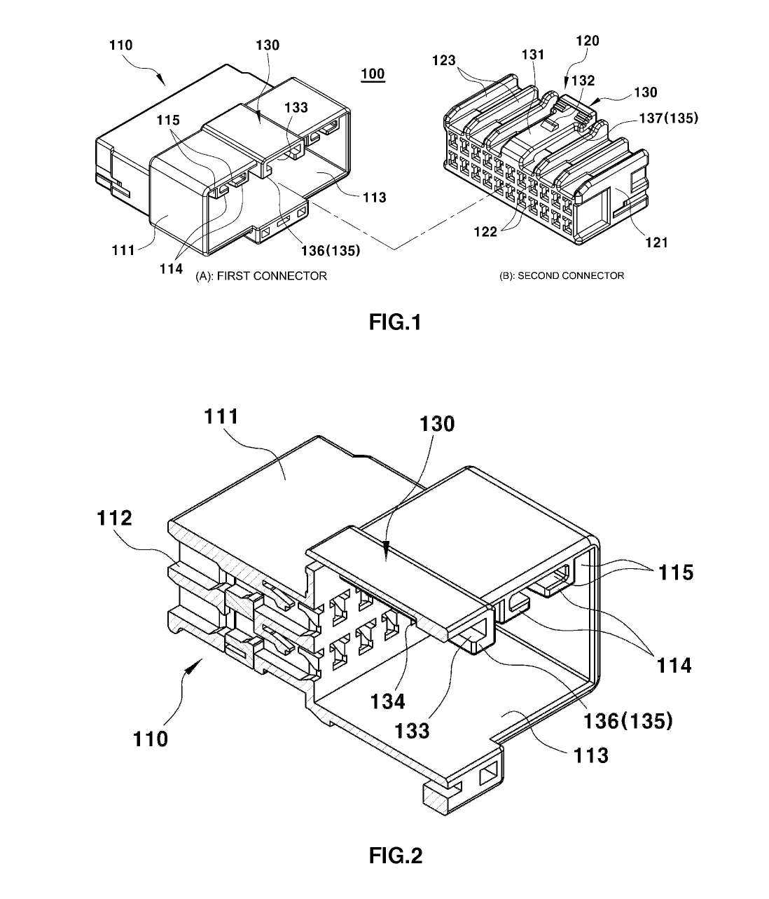

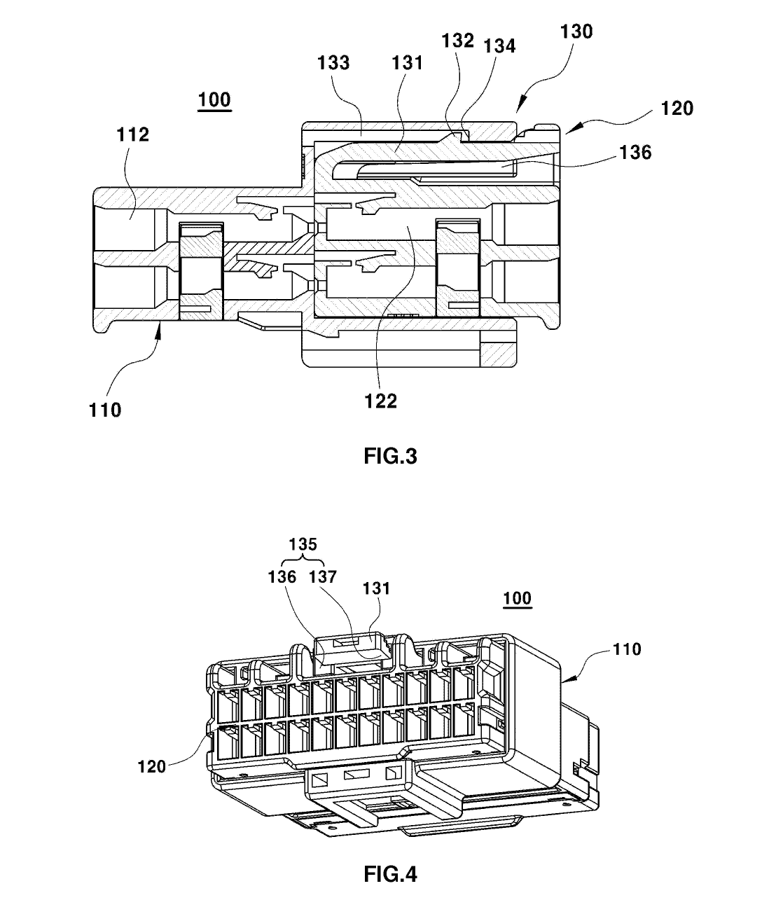

FIG. 1 is a perspective view illustrating a configuration of a connector assembly according to an embodiment of the present invention. FIG. 2 is a cross-sectional perspective view illustrating a first connector of the connector assembly of FIG. 1. FIGS. 3 and 4 are cross-sectional side and perspective views, respectively, illustrating coupling of first and second connectors of the connector assembly of FIG. 3.

A connector assembly 100 according to an embodiment of the present invention may include a first connector 110 and a second connector 120. Terminal receiving spaces 112 and 122 may be provided in housings 111 and 122 of the connector 110 and 120 such that terminals can be individually inserted into the terminal receiving spaces 112 and 122.

In the drawings, the terminals of each of connector 110 and 120 are not shown. A terminal may be formed in a first connector 110 to be inserted in a terminal of the second connector 120. In this case, the first connector 110 may become a male connector, and the second connector 120 may become a female connector.

The terminal of the first connector 110 may be formed to have a pin-like shape so as to be inserted into the terminal of the second connector 120. When the first connector 110 and the second connector 120 are coupled, the terminal of the first connector 110 may be inserted into the terminal of the second connector 120, enabling electrical connection.

Also, the housing 111 of the first connector 110 may have an insertion space 113 formed therein to receive a part of the housing 121 of the second connector 120. For coupling and terminal connection between the first and second connectors 110 and 120, the second connector 120 may be inserted into the insertion space 113 of the first connector 110.

A guide channel 115 may be disposed on the upper inner surface of the housing 111 of the first connector 110 at left and right sides of the insertion space 113 centered around a locking part 130, respectively. In this case, each guide channel 115 may be provided by forming a protrusion 114 of a “└ ┘” shape on the inner surface of the housing 111 of the first connector 110 along the insertion direction of the second connector 120.

The guide channel 115 may serve to guide coupling between the first connector 110 and the second connector 120 with a guide rib 123 inserted into the guide channel 115.

The guide rib 123 inserted into the guide channels 115 of the first connector 110 to be guided may be disposed on the top surface of the housing 121 of the second connector 120 at a location corresponding to the guide channel 115 so as to be inserted into each guide channel 115.

In this case, each guide rib 123 may be configured to protrude from the top surface of the housing 121 of the second connector 120 along the insertion direction into the inside of the first connector 110. Upon coupling of both connectors, each of the guide ribs 123 may be inserted and guided into each of guide channels 115 of the first connector 110 such that both connectors can be accurately coupled to each other.

On the other hand, the locking part 130 that locks both coupled connectors such that both connectors are not separated from each other may be integrally formed at the central portion of the housings 111 and 121 of each connector 110 and 120. The locking part 130 may be configured to perform a coupling assurance function that assures coupling between the connectors 110 and 120 so as to prevent a release of locking, along with a locking function that locks housings 111 and 121 of both connectors at the coupling location after both connectors are coupled to each other.

The locking part 130 may include an elastic locking lever 131 formed on an upper portion of the housing 121 of the second connector 120 and including a locking protrusion 132, a lever insertion part 133 formed on the housing 111 of the first connector 110 and including a stopping part 134 that stops the locking protrusion 132, and a coupling assurance part 135 integrally formed at the lever insertion part 133 and the locking lever 131 to prevent sagging and unlocking of the locking lever 131 by supporting the locking lever 131 such that the locking protrusion 132 can remain locked on the stopping part 134 after the coupling between connectors.

In particular, the lever insertion part 133 may be formed at the central portion of the inner surface of the housing 111 of the first connector 110 over the insertion space 113 to provide a space for receiving the locking lever 131. The stopping part 134 of the first connector 110, as shown in FIGS. 2 and 3, may be protrusively formed to have a stopping step shape that stops the locking protrusion 132 on the upper inner surface of the lever insertion part 133.

As shown in FIG. 3, the locking protrusion 132 may protrude from the top surface of the locking lever 131 so as to be stopped by the stopping part 134 of the lever insertion part 133 at a predetermined coupling location (complete coupling location between connectors). When the locking lever 131 is being supported by a coupling assurance part 135 integrally formed on the connector, the locking protrusion 132 may be stopped at the stopping part 134, thereby achieving a complete coupling state in which the second connector 120 is not separated from the first connector 110.

The coupling assurance part 135 may be a part that prevents coupling between connectors, i.e., locking state by the locking lever 131 from being undesirably released by surrounding conditions such as an external force. The coupling assurance part 135 may prevent the release of locking after coupling of connectors by stopping the locking lever 131 from sagging.

The coupling assurance part 135 may include a seating part 136 protruding in a lateral direction at a lower end of a lever insertion part 133 so as to be inserted into a lower side of the locking lever 131 (lower side of the protrusion of the locking lever described later) and thus support the locking lever 131.

Additionally, in an exemplary embodiment of the present invention, the coupling assurance part 135 may further include a protrusion part 137 integrally formed while protruding from both side surfaces of the end portion of the locking lever 131 such that the end portion of the locking lever 131 has a shape extending to left and right sides. The seating part 136 may support the protrusion part 137 of the locking lever 131.

In this case, the lever insertion part 133 and the seating part 136 may be formed to have a sectional shape of “└ ┘”. The lever insertion part 133 and the seating part 136 may be longitudinally formed on the inner surface of the first connector 110 over the insertion space 113 along the insertion direction of the second connector 120.

Also, in the lever insertion part 133, the seating part 136 may be formed at such a height as to upwardly push the locking lever 131 when being inserted into the lower side of the protrusion part 137.

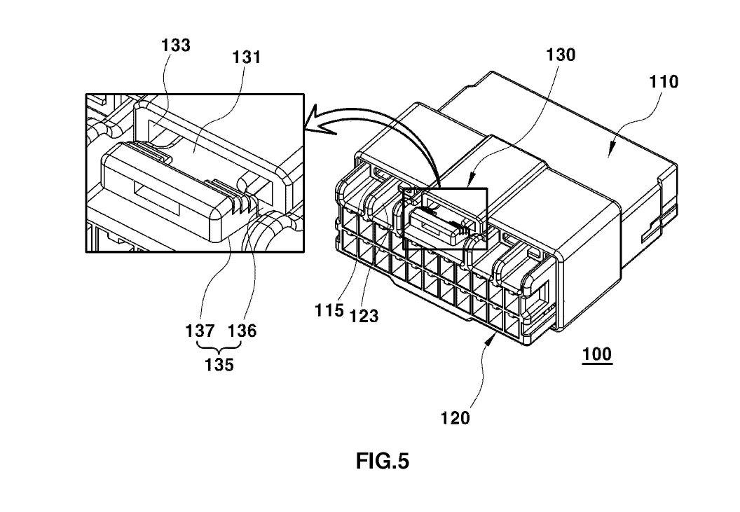

FIG. 5 is a perspective view illustrating a coupling state of connectors just before the complete coupling state is reached, which shows a state before the end portion of the locking lever 131 with the protrusion part 137 formed thereon is inserted into the lever insertion part 133 of the first connector 110.

When the second connector 120 is further inserted into the insertion space 113 of the first connector 110 until the state of FIG. 5 becomes the state of FIG. 4, the seating part 136 may be inserted into the lower side of the protrusion part 137 of the locking lever 131, thereby pushing up the locking lever 131.

Accordingly, while the locking lever 131 is being pushed up, the locking protrusion 132 of the locking lever 131 may be stopped by the stopping part 134 of the lever insertion part 133. In this state, the seating part 136 supports the locking lever 131 such that the locking lever does not sag downwardly, thereby maintaining the stopping state (locking state) between the locking protrusion 132 and the stopping part 134 and the complete coupling state between the connectors.

According to the connector assembly 100 according to the embodiment of the present invention, the coupling assurance structure is integrally formed on the connector so as to implement double locking on the locking lever 131 and accomplish coupling and position assurance between connectors only with a connector structure, not a separate element. The connector assembly can overcome the drawbacks of conventional CPAs that are formed separately from a connector to be coupled. In particular, increases of the number of components, manufacturing cost, man-hour, and whole size of the connector can be overcome.

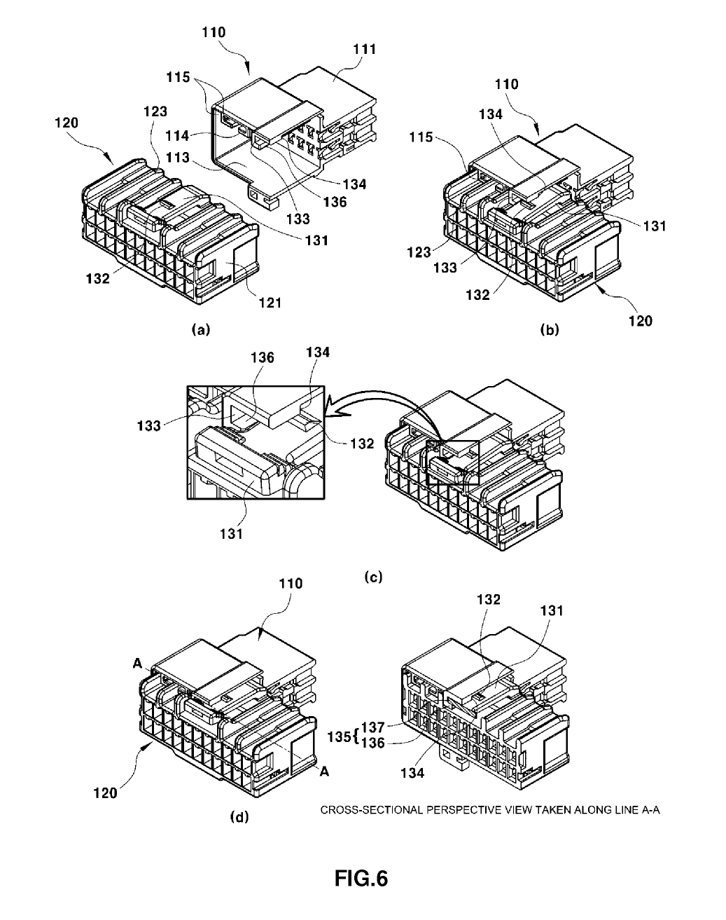

FIG. 6 depicts a coupling process of connectors of a connector assembly according to an embodiment of the present invention, where a portion of the first connector 110 is partially cut to show the internal coupling state of connectors.

FIG. 6A shows a state before the two connectors 110 and 120 are coupled to each other. In FIG. 6B, when the second connector 120 is inserted into the insertion space 113 of the first connector 110, the guide rib 123 of the second connector 120 may be inserted into the guide channel 115 of the first connector 110, and then the guide rib 123 may slide along the guide channel 115.

Also, the locking lever 131 of the second connector 120 may be inserted into the lever insertion 133 of the first connector 110. When the second connector 120 is inserted to a certain extent, the locking protrusion 132 may be pushed by the stopping part 134 from a location at which the locking protrusion 132 is interfered by the stopping part 134 protruding from the inner surface of the lever insertion part 133, allowing the locking lever 131 to be downwardly pushed.

FIG. 6C shows a state in which the locking protrusion 132 is being pushed by the stopping part 134 (the same state as FIG. 5). In FIG. 6C and FIG. 5 showing the state just before coupling between the connectors, when the first connector 110 is further inserted after the insertion of the second connector 120 is once stopped, the seating part 136 formed in the lever insertion part 133 may be inserted into the lower side of the protrusion part 137 formed on the locking lever 131, allowing the locking lever 131 to be pushed up.

Finally, the coupling state may become a complete coupling state as shown in FIG. 6D. In the complete coupling state, the locking state between the stopping part 134 and the locking protrusion 132 may be maintained, and simultaneously, the seating part 136 may support the locking lever 131, achieving a state where the sagging and unlocking of the locking lever 131 is prevented. In particular, a double locking state for the locking lever 131 may be reached.

According to a connector assembly according to an embodiment of the present invention, a coupling assurance structure is integrally formed on a connector so as to implement double locking on a locking lever and accomplish coupling and position assurance between connectors only with a connector structure, not a separate element. The connector assembly can overcome the drawbacks of conventional CPAs that are formed separately from a connector to be coupled. In particular, increases of the number of components, manufacturing cost, man-hour, and whole size of the connector can be overcome.

The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

What is claimed is:

1. A connector assembly, comprising:
a first connector installed with a terminal;
a second connector coupled to the first connector and insertedly installed with a terminal connected to the terminal of the first connector;
a locking lever disposed on the second connector and comprising a locking protrusion;
a lever insertion part disposed on the first connector such that the locking lever of the second connector is inserted into the lever insertion part and comprising a stopping part for stopping the locking protrusion; and
a coupling assurance part integrally formed with the lever insertion part and the locking lever and supporting the locking lever so as to maintain a locking state between the locking protrusion and the stopping part after the first and second connectors are coupled to each other.

2. The connector assembly of claim 1, wherein the coupling assurance part comprises:
a seating part laterally protruding from an lower end of the lever insertion part; and
a protrusion part integrally formed to have a protruding structure from a side surface of the locking lever,
wherein the seating part is inserted into a lower side of the protrusion part to support the locking lever.

3. The connector assembly of claim 2, wherein the lever insertion part and the seating part are formed to have a sectional shape of “└ ┘”, and are longitudinally disposed on an inner surface of the first connector in an insertion space of the first connector along an insertion direction of the second connector such that the locking lever and the protrusion part are inserted into the lever insertion part and the seating part.

4. The connector assembly of claim 2, wherein the protrusion part is integrally formed while protruding from both side surfaces of the end portion of the locking lever such that the end portion of the locking lever has a shape extending to left and right sides.

5. The connector assembly of claim 4, wherein the seating part is formed at such a height as to push up the locking lever when being inserted into the lower side of the protrusion part.

6. The connector assembly of claim 1, comprising a guide channel provided on an inner surface of an insertion space of the first connector for receiving the second connector by forming a protrusion of a “└ ┘” shape along the insertion direction of the second connector and a guide rib longitudinally disposed in the second connector along the insertion direction of the second connector to be inserted into each guide channel.

7. The connector assembly of claim 1, wherein the seating part is formed at such a height as to push up the locking lever when being inserted into the lower side of the protrusion part.

8. A coupling process of first and second connectors of a connector assembly, comprising steps of:
inserting the second connector into an insertion space of the first connector;
inserting a locking lever of the second connector into a lever insertion part disposed on the first connector, the first connector including a stopping part that protrudes from the lever insertion part of the first connector to stop a locking protrusion of the locking lever; and
providing a coupling assurance part integrally formed with the lever insertion part and the locking lever and supporting the locking lever so as to maintain a locking state between the locking protrusion and the stopping part after the first and second connectors are coupled to each other.
